(19) United States
(12) Patent Application Publication
(10) Pub. No.: US 2012/0310746 A1
(43) Pub. Date: Dec. 6, 2012

(54) LEARNED CONTEXT CORRELATION THROUGH NETWORK COMMUNICATION OBSERVATIONS

(75) Inventors: Jun Zhao, Beijing (CN); Kai Wang, Beijing (CN); Edward Ding-Bong Un, Beijing (CN)

(73) Assignee: MICROSOFT CORPORATION, Redmond, WA (US)

(21) Appl. No.: 13/154,220

(22) Filed: Jun. 6, 2011

(51) Int. Cl. G06Q 30/00; G06F 15/18; G06F 15/16

(52) U.S. Cl. 705/14.66; 709/224; 706/12

(57) ABSTRACT

Establishing a correlation between a user's context and wireless signal observations from that context enables wireless computing devices to provide users with targeted information. Rather than performing an expensive calibration, mobile sensor data indicative of a user's context is bundled with wireless signal observations and transmitted to server computing devices that can obtain a context from the mobile sensor data, correlate that to the wireless signal observations, and store the same in a context/wireless correlations database. When other wireless computing devices request a context based on wireless signal observations made by those wireless computing devices, reference can be made to the database and a context correlated to those wireless signal observations is obtained and provided to them, enabling targeted information to be delivered to their users. To accommodate heterogeneity among wireless computing devices the database maintains correlations according to the wireless computing devices from which the data originated.

### BACKGROUND

The convenience of wireless network connections, namely the convenience to maintain a communicational connection without physical attachment, has resulted in wireless networks being newly universally available. Unlike traditional wired network connections, a user communicationally coupled through a wireless connection can be in any one of a myriad of locations that support such wireless connectivity. Thus, determining the location of the user communicationally coupled through a wireless connection can be difficult.

Traditionally, user location determinations, within the context of wireless communication connections, were performed so as to identify the user's location to a high degree of accuracy. For example, such user location determinations were utilized to associate the user with a given printer, such that a user attempting to print a document would find that the document automatically printed at the printer closest to the user. Alternatively, as another example, such user location determinations were utilized to associate the user with a given conference room, such that a user attempting to reserve a conference room would have the conference room closest to their current location automatically selected for them. For such purposes, the determination of a user's location can require a high degree of accuracy, since there can exist a number of, for example, printers within a relatively small area, such that inaccurate determinations of the user's location can result in that user's documents being printed to an inconvenient printer.

Additionally, for such purposes, it can be economically viable to invest the time and resources to perform the sorts of calibrations that are necessary to utilize wireless signal information to derive a user's location. In particular, existing mechanisms for determining a user's location based on observations of wireless signals, as they are received at the wireless computing device being utilized by the user at their location, require substantial calibration. For example, detailed measurements of wireless signals can be undertaken at a myriad of locations, and in a myriad of orientations of the wireless computing device at those locations. A user's location, then, can be determined by reference to these calibration measurements. As such, any changes in the environment, including changes in the wireless communication infrastructure, or in the physical environment within which the measurements were made, can require performing the detailed calibration yet again.

For other purposes, however, a user's location need not be determined to a high degree of accuracy. Alternatively, the reason for desiring a user's location may not be sufficiently economically important to justify undertaking the time and expense to perform the sort of detailed calibration that would be required. For example, merchants or advertisers can target offers to users that are known to be in a particular location, especially within the context of a retail establishment. A user standing in, for example, a beverage aisle in a grocery store may be more likely to take advantage of an advertisement or targeted offer regarding a particular brand of beverage, then a user standing in, for example, the produce aisle. However, for purposes of targeting such offers to users, it may be sufficient to be able to deliver such offers to users that are merely close to, for example, the beverage aisle. Additionally, advertisers and merchants may not be willing to pay substantially more for the ability to target information to users based on those users' locations.

### SUMMARY

In one embodiment, mobile sensor data, such as would be acquired by a user utilizing a wireless computing device that is wirelessly communicationally coupled to a network, in combination with wireless signal observations, can be utilized to generate a context/wireless correlations database from which other users' contexts, including their locations, can be derived based only on the wireless signals observed by those users' wireless computing devices

In another embodiment, a user's wireless computing device, when capturing mobile sensor data, can additionally capture wireless signal observations at that time, and then transmit both to one or more server computing devices. The captured mobile sensor data can comprise any information that is indicative of the context of the wireless computing device when capturing that data. For example, if a user uses their wireless computing device to scan a barcode for, for example, performing a price comparison, such a barcode can be mobile sensor data that, with reference to a context information database, can be utilized to determine the context, such as the location within a particular retail establishment, at which such a barcode was acquired.

In a further embodiment, one or more server computing devices can receive mobile sensor data and corresponding wireless signal observations from wireless computing devices that are wirelessly communicationally coupled to the server computing devices. By referencing a context information database, a context of the wireless computing device, at the time that the wireless computing device captured the mobile sensor data, can be obtained. Such a context can then be correlated to the wireless signal observations, and that correlation can be retained in a context/wireless correlations database.

In a still further embodiment, one or more server computing devices can receive wireless signal observations from wireless computing devices that are wirelessly communicationally coupled to the server computing devices, as well as a request to provide a context corresponding to the wireless signal observations. The context/wireless correlations database can be referenced to find a most appropriate context based on the wireless signal observations that were received. Such a context can then be returned to the wireless computing devices. Optionally, in addition with context, targeted information that is associated with such a context, such as advertisements or offers, can likewise be provided to the wireless computing devices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary environment within which a correlation between wireless signal observations and context can be obtained and utilized;

FIG. 2 is a block diagram of exemplary computing devices that can provide for, and utilize, a correlation between wireless signal observations and context;

FIG. 3 is a flow diagram of an exemplary operation of a wireless computing device;

FIG. 4 is a flow diagram of an exemplary operation of one or more server computing devices; and

FIG. 5 is a block diagram of an exemplary computing device.

### DETAILED DESCRIPTION

The following description relates to mechanisms for establishing a correlation between a user's context and wireless signal observations from that context to enable wireless computing devices so as to then be able to provide users with targeted information based, at least in part, on a determined context of those users. Rather than performing an expensive and time-consuming calibration, mobile sensor data that can be indicative of a user's context at the time that it was captured by a wireless computing device can be bundled with wireless signal observations from that same time, and transmitted to one or more server computing devices that can obtain a context from the mobile sensor data, correlate that context to the wireless signal observations, and store the same in the context/wireless correlations database. When other wireless computing devices request a context based on wireless signal observations made by those wireless computing devices, the one or more server computing devices can reference the context/wireless correlations database and obtained therefrom a context that is correlated to the wireless signal observations provided by those other wireless computing devices. Utilizing such a context, the wireless computing devices can, either individually, or with the help of the one or more server computing devices, provide targeted information to the user, such as offers or advertisements. Because differing wireless computing devices may record different wireless signal observations even within a common location, the context/wireless correlations database can maintain data grouped according to wireless computing devices. If insufficient data exists from similar wireless computing devices, reference can be made to the data obtained from other wireless computing devices, when seeking to associate a context with obtained wireless signal observations, except that such data from other wireless computing devices can be weighted appropriately.

For purposes of illustration, the techniques described herein make reference to wireless networks, but such references are strictly exemplary and are not intended to limit the mechanisms described to only short-range wireless networks. Indeed, the techniques described are equally applicable to any wireless communicational connection. Additionally, for purposes of illustration, the techniques described herein make reference to wireless networks that are utilized to provide a communicational connection to a further, broader, network of computing devices. However, the techniques described do not require such connectivity and are equally applicable to communications within local area, or wide area, networks.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

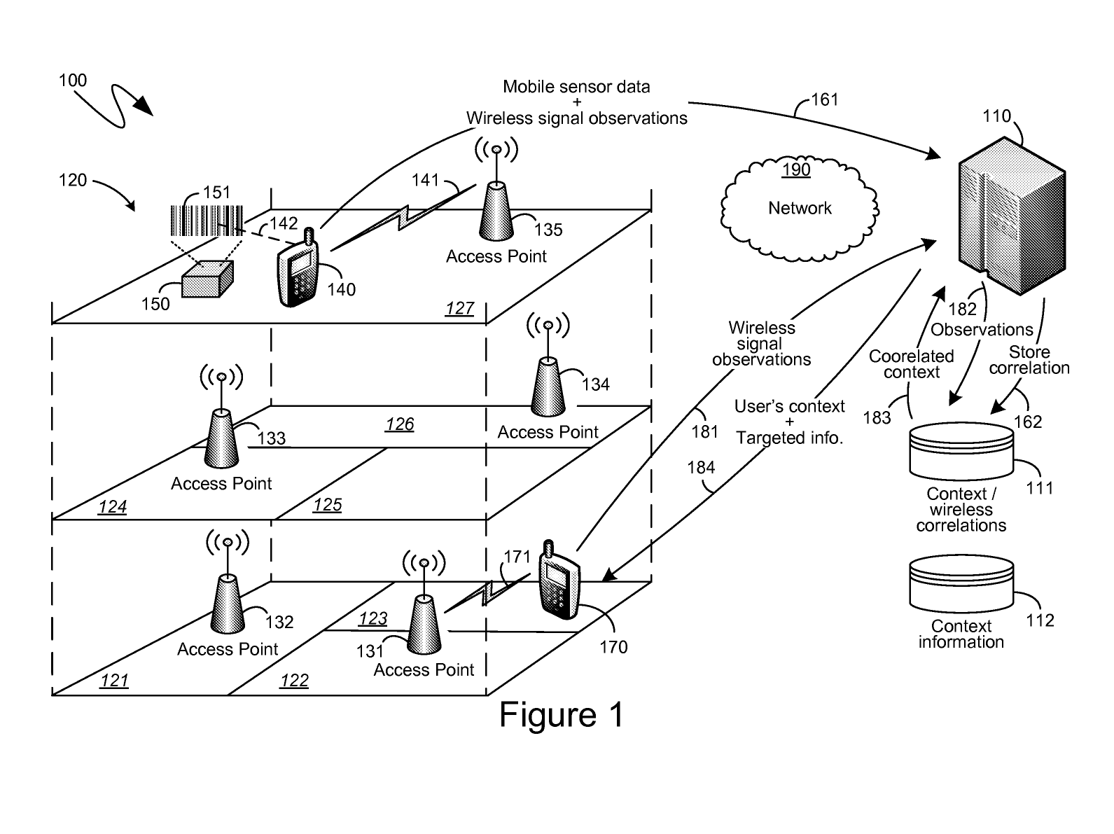

Turning to FIG. 1, a system 100 is shown, comprising an environment 120 within which the context of a user, such as that user's location within the environment 120, can be utilized to provide targeted information to that user, such as through a wireless computing device that the user can carry with them. For example, the environment 120 can be a multistory retail environment, such as a mall, a store, a supercenter, or other like retail environment. For purposes of illustration, the retail environment 120 is shown as comprising three floors, or stories, having regions 121, 122 and 123 on the first floor, regions 124, 125 and 126 on the second floor, and region 127 on the third floor. Such regions can represent different retail areas of the retail environment 120. For example, if the retail environment 120 were a shopping mall, the regions 121 through 127 can represent different stores, or other like retail establishments, that can be in the shopping mall retail environment 120. Alternatively, if, for example, the retail environment 120 were a store, the regions 121 to 127 can represent different regions, or isles, of the store.

The retail environment 120 can comprise, such as for the convenience of its patrons, a wireless network that can comprise one or more wireless access points, such as the wireless access points 131 and 132 on the first floor, the wireless access points 133 and 134 on the second floor, and the wireless access point 135 on the third floor. Although not specifically shown in the system 100 of FIG. 1, the wireless access points 131 to 135 can further comprise a communicational connection with the network 190, such as through an internetwork routing device, to enable those computing devices that are communicationally coupled to one or more of the wireless access points 131 to 135 to communicate with computing devices that are communicationally coupled to, or are considered part of, the network 190.

Additionally part of the system 100 of FIG. 1 can be one or more server computing devices, represented by the server computing device 110, that can maintain the communicational connection to a context/wireless correlations database 111 and a context information database 112. Although, again, not specifically illustrated in FIG. 1, the server computing device 110 can be communicationally coupled with the network 190 such that computing devices that are wirelessly communicationally coupled to the network 190, through the wireless access points 131 through 135, can establish communicational connection with the server computing device 110.

In one embodiment, one or more wireless computing devices, such as the wireless computing devices 140 and 170, can be utilized by the user, while the user is in the retail environment 120, to obtain mobile sensor data that can provide information about the context of the user at the time that that mobile sensor data was obtained. As utilized herein, the term “mobile sensor data” means any data, obtained by a computing device, that comprises indicia of the context of the user utilizing such a computing device at the time that the computing device obtained that data. For example, mobile sensor data can comprise scans of barcodes, pictures of items, manual entry of product identifying numbers, and other like data that can be obtained by a computing device.

As shown in the system 100 of FIG. 1, a user can utilize the wireless computing device 140 to scan, as illustrated by the dashed line 142, a barcode 151 of a product 150 that the user was contemplating purchasing. For example, the user could utilize the wireless computing device 140, with the scanned barcode 151, to look up pricing information regarding the product 150, such as via the network 190, to determine whether the price of the product 150, as offered at the retail environment 120, is appropriate. The ability of users to utilize wireless computing devices, such as the wireless computing device 140, to scan 142 product information, such as the barcode 151, and utilize such information for price comparison purposes, is, as will be known by those skilled in the art, already available through a number of mechanisms.

In one embodiment, however, computer-executable instructions executing on the wireless computing device 140 can utilize the obtained mobile sensor data, such as, in the particular example shown in the system 100 of FIG. 1, the scan 142 of the barcode 151, and can combine such obtained mobile sensor data with wireless signal observations that were made at the time of the scan 142, and can transmit such a collection of information to the server computing device 110, as illustrated by the communication 161. For example, an application program executing on the wireless computing device 140 can provide for the above referenced price comparison functionality, such that the user utilizes such an application program to scan 142 the barcode 151 and obtain, from that application program, price comparison functionality. Such an application program can also provide for the collection of wireless signal observations at the time that the wireless computing device 140 is utilized to scan 142 the barcode 151, and can generate and transmit the communication 161 to the server computing device 110. In an alternative embodiment, the application program, or other collection of computer-executable instructions, that generates the combination of the mobile sensor data in the wireless signal observations that are transmitted, via the communication 161, to the server computing device 110, can be separate from the application program that the user of the wireless computing device 140 is utilizing to perform the price comparison functionality. In such an alternative embodiment, the latter application program can obtain the mobile sensor data from the former application program, such as through existing operating system functionality, or by specifically requesting the same from the former application program directly.

In one embodiment, the wireless signal observations that can be obtained by the wireless computing device 140 can comprise a signal strength of the wireless access point to which the wireless computing device 140 is communicationally coupled. For example, in the system 100 illustrated in FIG. 1, the wireless computing device 140 is illustrated as being wirelessly communicationally coupled to the access point 135, such as via the wireless communicational connection 141. Thus, in such an example, the signal strength that can be part of the wireless signal observations can be the signal strength of the communications from the access point 135. Additionally, in another embodiment, the wireless signal observations that can be obtained by the wireless computing device 140 can comprise other information, such as about the access point 135, or the wireless network connection 141 being maintained by the wireless computing device 140 with the access point 135. In such other embodiments, the wireless signal observations can comprise the Basic Service Set Identifier (BSSID) of the wireless access point 135, the Service Set Identifier (SSID) of the wireless access point 135, the wireless network type and channel of the wireless communicational connection 141 between the wireless computing device 140 and the access point 135, and timing information about the wireless communication connection 141. In still other embodiments, the wireless signal observations can comprise identifying information about the wireless computing device 140 itself, such as, for example, the type of wireless computing device, the manufacturer of the wireless computing device, the model identifier of the wireless computing device, the MAC address of the wireless computing device and other like information.

As indicated previously, the mobile sensor data and the wireless signal observations obtained at the time that the mobile sensor data was obtained can be transmitted, from the wireless computing device 140, to one or more server computing devices, such as the server computing device 110, as illustrated by the communication 161. Upon receiving the mobile sensor data and wireless signal observations, the server computing device 110 can reference a context information database 112 to obtain a context associated with the received mobile sensor data. The context information database 112 can be a database that can be maintained by, or that can incorporate data maintained by, the owner or administrator of the retail environment 120. Additionally, the context information database 112 can be a database that can incorporate information from external sources, such as, for example, product information maintained by individual product manufacturers.

By referencing the context information database 112, the server computing device 110 can obtain a context associated with the received mobile sensor data. For example, if the mobile sensor data comprises the barcode 151, the context information database 112 can comprise information linking the barcode 151 to the product 150, as well as information identifying the product 150 as being located on the third floor of the retail environment 120, within the region 127. In one embodiment, the context information database 112 can identify the location of the product 150, within the retail environment 120, to a fair degree of precision, such as, for example, the specific shelf, aisle, or other like information at which the product 150 is located. The location information obtained from the context information database 112 can be one aspect of the context that can be associated with the wireless signal observations that were received by the communication 161. Other aspects can include information such as, for example, whether the merchant of the product 150 in the retail environment 120 accepts coupons, whether there are any targeted offers or other like targeted information associated with the product 150, or other products that may be proximate to the product 150 in the retail environment 120, and other like contextual information.

In one embodiment, the obtained contextual information can be correlated with the wireless signal observations that were received via the communication 161, and such a correlation can be stored in the context/wireless correlations database 111, by the server computing device 110. In another embodiment, the server computing device 110 need only correlate the received wireless signal observations with a context identifier for purposes of storing such a correlation into the correlations database 111. The storing of a correlation into the context/wireless correlations database 111 is illustrated by the communication 162, shown in the system 100 of FIG. 1.

Another computing device, such as the wireless computing device 170, which can maintain a wireless communicational connection 171 with the access point 131, can transmit its wireless signal observations to the server computing device 110, such as via the communication 181 that is shown in the system 100 of FIG. 1. The communication 181 can further comprise a request, whether implicit or explicit, from the wireless computing device 170, requesting that the server computing device 110 provide a context associated with the wireless signal observations as recorded and transmitted by the wireless computing device 170. Given that the wireless computing device 170 is likely being carried by a user, the context of the wireless computing device 170 will also, likely, be the context of the user utilizing such a computing device. Consequently, once the context of that wireless computing device is known, the user can receive targeted information that is associated with that context, and such targeted information will likely be useful to the user, given their current context.

In one embodiment, upon receiving the wireless signal observations, such as via the communication 181, the server computing device 110 can provide such observations to the context/wireless correlations database 111, as illustrated by the communication 182, and receive therefrom context that is correlated to those wireless signal observations, such as is illustrated by the communication 183. The correlated context, such as that received by the communication 183, can then be provided by the server computing device 110 back to the wireless computing device 170, such as is illustrated by the communication 184. The wireless computing device 170 can then utilize that context to provide targeted information to its user. For example, if the context indicates that the wireless computing device 170 is in the region 123 of the retail environment 120, it can present, to its user, targeted offers or advertisements for products sold in the region 123, or other targeted offers or advertisements that those advertisers sought to display to users that would be physically located within the region of 123. As one example, if the region 123 represented a shoe store, the receipt of the context information, such as via the communication 184, can trigger one or more sets of computer-executable instructions executing on the wireless computing device 170 to present, to its user, coupons or advertisements for specific shoes. As another example, if the region 123 represented a restaurant, the receipt of the context information, such as via the communication 184, can trigger one or more sets of computer-executable instructions executing in the wireless computing device 170 to present, to its user, coupons or advertisements for other restaurants that may seek to entice the user away from the restaurant in the region 123.

In one embodiment, the targeted information presented to the user can be selected locally by the wireless computing device itself. In another embodiment, however, the targeted information presented to the user can be selected remotely, such as by the server computing device 110, based on the context information determined, by the server computing device 110, to be correlated to the wireless signal observations that were received. In such an embodiment, the context information database 112 can further comprise, or provide access to, targeted information that is associated with one or more contexts. That targeted information can then be provided, such as by the server computing device 110, to a wireless computing device, such as the wireless computing device 170, as illustrated by the communication 184.

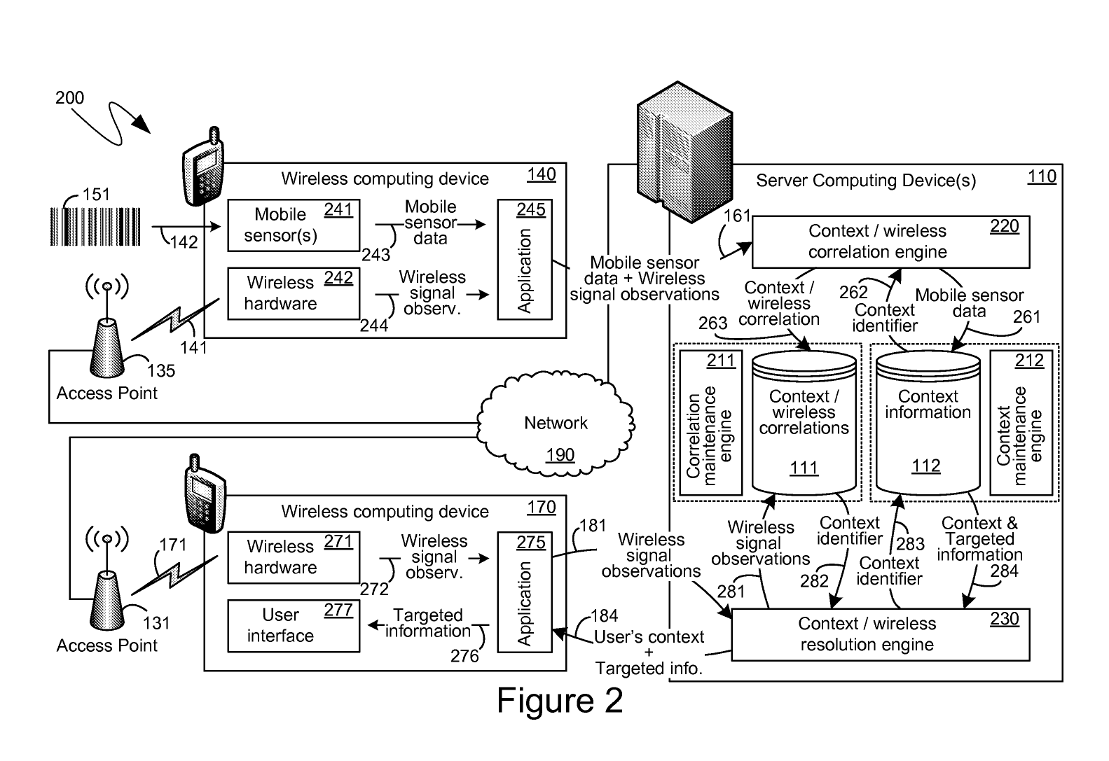

Turning to FIG. 2, the system 200 shown therein illustrates the wireless computing devices 140 and 170, and the one or more server computing devices, such as the server computing device 110, in greater detail. As shown, the wireless computing device 140 can comprise one or more mobile sensors 241 that can capture mobile sensor data 243. As indicated previously, in one embodiment, one such mobile sensor can be a camera or other optical scanner or capture device that can scan 142 a barcode 151, such as is illustrated by the system 200 of FIG. 2. As also indicated previously, the mobile sensors 241 can comprise other data capture aspects of the wireless computing device 140, including a microphone, a keyboard, a touchscreen, or other like data entry mechanism, by which data that can identify a context within which the wireless computing device 140 is operating can be entered into the wireless computing device 140.

The wireless computing device 140 can further comprise wireless hardware 242 that can capture wireless signal observations 244. As indicated previously, wireless signal observations 244 can include the signal strength, such as of the wireless communicational connection 141 with a wireless access point 135, and it can also include other parameters or identifying aspects of the access point 135, the wireless communication connection 141, and the wireless computing device 140, such as the BSSID, the SSID, the wireless communication type and channel, the manufacturer, the model identifier, the type, the MAC address, and other like information.

An application 245 can execute on the wireless computing device 140 and can receive the mobile sensor data 243 and the wireless signal observations 244 and combine them for transmission to the server computing device 110, such as is illustrated by the communication 161. In one embodiment, the application 245 can coordinate between the mobile sensors 241 and the wireless hardware 242 such that, when at least one of the mobile sensors 241 receives the mobile sensor data 243, the application 245 can trigger the wireless hardware 242 to capture the wireless signal observations 244 at that time. As indicated previously, the application 245 can be the application that the user of the wireless computing device 140 utilizes to perform other functions that happen to collect the mobile sensor data 243. For example, the application 245 can be a price comparison application that a user of the wireless computing device 140 can utilize to compare prices of products. In such an example, the application 245 can utilize the mobile sensors 241 to scan 142 the barcode 151 and then utilize the information from the barcode 151 to provide price comparison functionality to the user of the wireless computing device 140. The application 245 could then also ordinate with wireless hardware 242 and combine the received mobile sensor data 243, which it used for other purposes, with the wireless signal observations 244 and transmit the same to the server computing device 110, as illustrated by the communication 161. Alternatively, in another embodiment, the application 245 can be a dedicated application that obtains the mobile sensor data 243 when other applications on the wireless computing device 140 utilize the mobile sensors 241 to obtain the mobile sensor data 243 for themselves. In such an embodiment, the application 245 can obtain the mobile sensor data 243 either through interfaces made available by the operating system of the wireless computing device 140, or by communicating with such other application programs that are directing the collection of the mobile sensor data 243.

The mobile sensor data 243 and the associated wireless signal observations 244 can be provided to a context/wireless correlation engine 220 that can execute on one or more server computing devices, such as the server computing device 110. As illustrated by the communication 261, the context/wireless correlation engine 220 can utilize the obtained mobile sensor data to reference the context information database 112, and obtain therefrom a context identifier, as illustrated by the communication 262. As indicated previously, the context information database 112 can comprise, or can provide access to, information that can associate information received from the mobile sensor data 243, as provided by the communication 261, with other information that can be tied to a particular location or other contextual information that can be utilized to determine which targeted information, if any, to present to a user of the wireless computing device that captured the mobile sensor data 243. For example, the context information database 112 can comprise product identifiers or other product identifying information, product locations at various retail environments, such as the retail environment 120 illustrated in FIG. 1, further information about those retail environments, such as, for example, whether or not they accept coupons, and other like contextual and location information.

Thus, as illustrated by the system 200 of FIG. 2, the mobile sensor data 243, or information therefrom, can be provided to the context information database 112 by the communication 261. For example, the bar code 151, or information therefrom, can be provided to the context information database 112 via the communication 261. The context information database 112 can comprise information linking the bar code 151 to a particular product, as well information identifying the location of such a product within one or more retail environments, such as, for example, identifying the location of the product 150 in the corner of the region 127 in the retail environment 120, as illustrated in FIG. 1. In one embodiment, additional information available to the context/wireless correlation engine 220 can be provided, along with the mobile sensor data 243, as part of the communication 261, to the context information database 112. For example, to identify the retail environment from which the mobile sensor data 243 was received, the context/wireless correlation engine 220 can additionally provide at least some of the wireless signal observations, such as, for example, those aspects of the wireless signal observations that identify the access point 135. In such an embodiment, the context information database 112 can further comprise information linking access points to the retail environments within which those access points are deployed. Thus, for example, the context information database 112 can further comprise information identifying the access point 135 as an access point that is located within the retail environment 120, shown in FIG. 1. In such a manner, the context information database 112 can, based on the information received via the communication 261, identify the context, such as the location, of a user of the wireless computing device 140 when such mobile sensor data 243 was captured by that wireless computing device 140. In the above example, for example, the context information database 112 can determine that the wireless computing device 140 was in a corner of the region 127 in the retail environment 120, shown in FIG. 1, when it captured the barcode 151, since that barcode corresponds to a product 150, shown in FIG. 1, that is located in a corner of the region 127 in the retail environment 120, and since identifiers of the access point 135 indicate that the wireless computing device 140 captured the barcode 151 in the retail environment 120, as opposed to some other retail environment.

Such context information, including, for example, the location of the wireless computing device when it captured mobile sensor data, as well as other contextual information, can be returned to the context/wireless correlation engine 220, from the context information database 112, via the communication 262, as shown by the system 200 of FIG. 2. In one embodiment, the context information database 112 can return, to the context/wireless correlation engine 220, one or more identifiers of the determined context. The context/wireless correlation engine 220 can then correlate the wireless signal observations 244, that were received via the communication 161, with the one or more identifiers of the determined context that were received from the context information database 112, such as via the communication 262. This correlation can then be stored in the context/wireless correlations database 111, by the context/wireless correlation engine 220, as illustrated by the communication 263 shown in the system 200 of FIG. 2.

In one embodiment, to address the heterogeneity of various different types of wireless computing devices, the context/wireless correlation engine 220 can store correlations in the context/wireless correlations database 111 in accordance with the type of wireless computing device from which the mobile sensor data and wireless signal observations were received. More specifically, and as will be recognized by those skilled in the art, different types of wireless computing devices may sense wireless signals, especially wireless signal strengths, differently. Thus, for example, a tablet-based wireless computing device may comprise larger wireless antennae and, as such, may sense stronger wireless signals than, for example, a smartphone-based wireless computing device at the exact same location, due to the smartphone-based wireless computing device likely comprising smaller wireless antennae due to its physically smaller form factor. Consequently, the context/wireless correlation engine 220 stores correlations into the context/wireless correlations database 111 in accordance with the wireless computing device that provided the mobile sensor data and wireless signal observations. In one embodiment, such correlations are stored into the context/wireless correlations database 111 in accordance with the specific make and model identifier of the wireless computing device, while, in other embodiments, such correlations are stored in accordance with merely categorizations of the wireless computing device, such as, for example, whether the wireless computing device is of a tablet form factor, a smartphone form factor, or a laptop form factor.

In one embodiment, the context/wireless correlations database 111 can be associated with a correlation maintenance engine 211 that can enable an administrator to directly edit one or more of the correlations stored in the context/wireless correlations database 111. For example, if a retail environment were to close, an administrator could utilize the correlation maintenance engine 211 to access the context/wireless correlations database 111 and delete all correlation entries associated with the now closed retail environment. Similarly, as another example, if a retail environment were to change the location of one or more product, such as, for example during a holiday sales season when seasonal products are added to the retail environment and other products are moved to make room for them, an administrator could utilize the correlation maintenance engine 211 to appropriately either modify or delete those correlations, in the context/wireless correlations database 111, that are no longer valid given the, for example, seasonal product location changes.

In another embodiment, changes in the locations of products, changes to the locations or number of access points, or other like changes to the retail environment, can simply be accommodated through an aging process applied to the entries in the context/wireless correlations database 111. More specifically, the context/wireless correlation engine 220 can, when providing correlations to the context/wireless relations database 111, such as via the communication 263, also include, with those correlations, temporal information, such as a date or timestamp that can identify when the data upon which that correlation is based was acquired. Subsequently, as will be described further below, when referencing the context/wireless correlations database 111 to identify a context correlated to wireless signal observations, more recent entries can be weighted more strongly than older entries.

Like the context/wireless correlations database 111, the context information database 112 can, likewise, be associated with a maintenance engine, namely the context maintenance engine 212. Like the correlation maintenance engine 211, the context maintenance engine 212 can enable an administrator to modify or delete information in the context information database 112. For example, if a retail environment were to change the location of certain products, either temporarily, such as during a seasonal promotion, or permanently, an administrator could utilize the context maintenance engine 212 to update the information in the context information database 112 to reflect the new locations of such products. Similarly, if a retail environment were to, for example, sell its existing access points and purchase new access points, the identifiers of the access points associated with such a retail environment can be changed in the context information 112, such as by the context maintenance engine 212. As yet another example, if a retail environment were to change its policy on, for example, accepting coupons, then the context maintenance engine 212 could be utilized to update such information in the context information database 112.

In one embodiment, the context information database 112 can either be maintained independently of the context/wireless correlations database 111, or it can reference information that can be maintained independently. In such an embodiment, the context maintenance engine 212 can comprise an interface, such as a front-end presented through the ubiquitous World Wide Web, that can enable owners or managers of retail environments to logon and update their information, such as, for example, identifiers of access points that that retail environment has deployed, information about the retail environment, including the locations of various products, and policies of the retail environment, such as, for example, whether the retail environment accepts coupons.

The information collected in the context/wireless correlations database 111 can be utilized to provide context information to wireless computing devices based on the wireless signal observations that those devices are making. For example, the wireless computing device 170 can comprise wireless hardware 271 that can be analogous to the wireless hardware 242 of the wireless computing device 140. Such wireless hardware 271 can maintain a wireless communicational connection 171 with an access point 131, as shown in the system 200 of FIG. 2. Like the wireless hardware 242, the wireless hardware 271 can make observations of the wireless communicational connection 171, in the form of wireless signal observations 272 which, like the wireless signal observations 244, can comprise a BSSID, an SSID, signal strength, frequency and channel utilized, and other like information.

The wireless signal observations 272 can then be provided to an application 275 that can be executing in the wireless computing device 170. For example, the application 275 can be an application that polls the wireless hardware 271 for the wireless signal observations 272 in order to deliver targeted information 276 to a user of the wireless computing device 170. When the application 275 receives the wireless signal observations 272 from the wireless hardware 271, it can provide them to one or more server computing devices, such as the server computing device 110, via the communication 181, as shown in the system 200 of FIG. 2. Within the server computing device 110, the communication 181 can be received by a context/wireless resolution engine 230. Upon receiving wireless signal observations, such as via the communication 181, the context/wireless resolution engine 230 can reference the context/wireless correlations database 111 to find at least one context correlated to the wireless signal observations 272 that were received via the communication 181. Thus, as shown in the system 200 of FIG. 2, the context/wireless resolution engine 230 can provide the wireless signal observations 272 to the context/wireless correlations database 111, as indicated by the communication 281. In response, the context/wireless resolution engine 230 can obtain, from the context/wireless correlations database 111, an identifier of a context correlated to the wireless signal observations 272, that were provided via the communication 281. Such a correlated context identifier can be provided to the context/wireless resolution engine 230 via the communication 282, as illustrated by the system 200 FIG. 2.

In one embodiment, when searching the context/wireless correlations database 111 for contexts that are correlated to the wireless signal observations 272, provided via the communication 281, the context/wireless resolution engine 230 can initially search for correlations that are based on data collected by the same type of wireless computing device as the wireless computing device 170 from which the wireless signal observations 272 were received. If there is a sufficient amount of data in the context/wireless correlations database 111, the context/wireless resolution engine 230 can find one or more correlations that were made based on data acquired by a wireless computing device having the same model and manufacturer as the wireless computing device 170. If such correlations cannot be found, then other correlations made based on data acquired by wireless computing devices of the same type can be utilized. Correlations that are based on data acquired by wireless computing devices that differ from the wireless computing device 170 can be weighted appropriately to account for differences in the way wireless computing devices perceive wireless signals. Additionally, as indicated previously, correlations can be aged such that older correlations are weighted less than newer correlations. In such a manner, the context/wireless resolution engine 230 can account for the possibility that the locations of products upon which such correlations are based may have changed over time.

Once the correlation is identified, such as by the above-described reference of the context/wireless correlations database 111, the context/wireless resolution engine 230 can receive an identifier of that correlated context, such as via the communication 282 that is shown in the system 200 of FIG. 2. The context/wireless resolution engine 230 can then provide that context identifier to the context information database 112, such as via the communication 283, as shown, in order to obtain the contextual information associated with that context identifier. Such contextual information can be returned to the context/wireless resolution engine 230, such as via the communication 284. The context/wireless resolution engine 230 can then provide that context to the application 275, via the communication 184.

The application 275, executing on the wireless computing device 170, can, upon receiving the contextual information via the communication 184, generate targeted information 276 that can be provided to a user of the wireless computing device 170, such as through a user interface 277. In one embodiment, the targeted information 276 can comprise offers or announcements that can be relevant to a user in the identified context. For example, the targeted information 276 can comprise coupons that can be accepted by the retail environment in which the user is currently located, as indicated by the context provided by the context/wireless resolution engine 230, and can be for products that are proximate to the user's current location, as also indicated by the provided context. As another example, the targeted information 276 can comprise information regarding offers or features of retail environments that are in competition with the retail environment in which the user is currently located, again as indicated by the provided context.

In one embodiment, the targeted information 276 can be generated by the application 275 with reference to the context received from the context/wireless resolution engine 230. In generating such targeted information 276, the application 275 can reference external data sources, such as servers or services set up by one or more retail establishments. In an alternative embodiment, however, the targeted information 276 can be provided by the server computing device 110. In such an alternative embodiment, the context information database 112 can comprise the targeted information 276 as well, which can be provided to the context/wireless resolution engine 230, such as via the communication 284. That targeted information can then be provided to the application 275, by the context/wireless resolution engine 230, via the communication 184. In such a manner, wireless computing devices can provide targeted information to users without requiring a detailed calibration of one or more wireless networks, such as can be offered by retail establishments and environments. Additionally, as will be recognized by those skilled in the art, the server computing device 110 can continue to receive mobile sensor data and wireless signal observations, such as those provided via the communication 161, and can continue to update the context/wireless correlations database 111 and the context information database 112, while additionally providing contextual information, such as that of the context/wireless resolution engine 230, to other wireless computing devices.

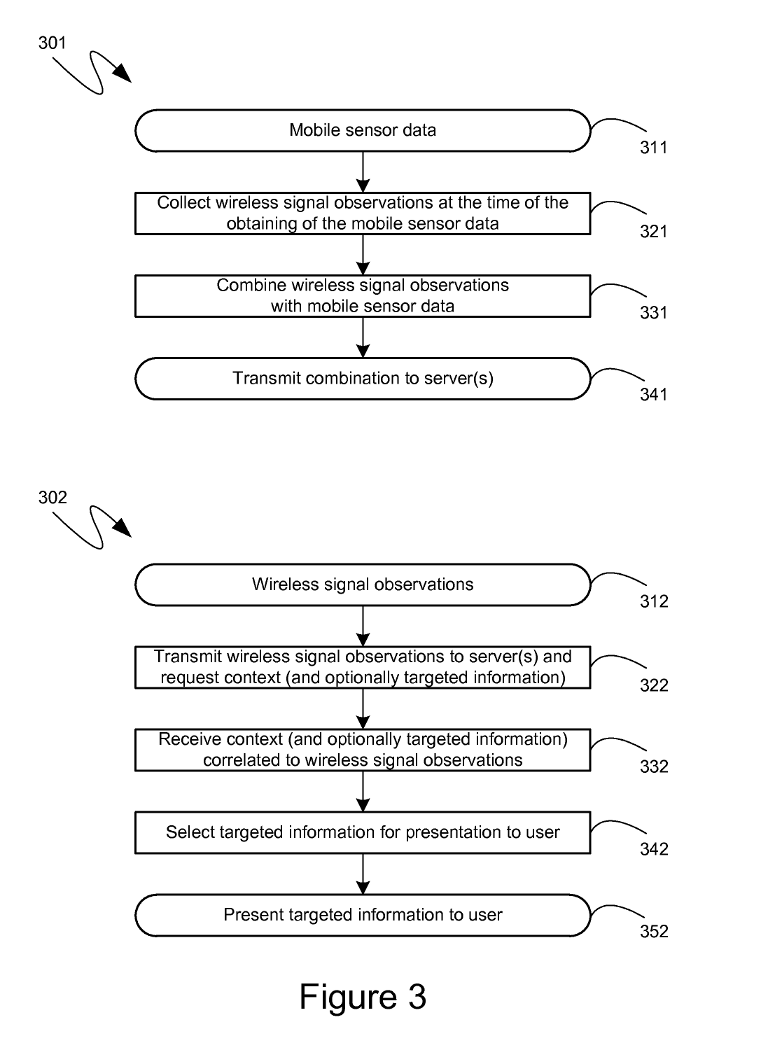

Turning to FIG. 3, the operation of one or more collections of computer-executable instructions executing on a wireless computing device is illustrated with respect to flow diagrams 301 and 302, which can operate concurrently on one or more wireless computing devices. In particular, at step 311 of the flow diagram 301, the wireless computing device can obtain mobile sensor data, which, as indicated previously, can comprise any data, received by the wireless computing device, which can provide an indication of the current context within which that wireless computing device finds itself at that time. Subsequently, at step 321, wireless signal observations at the time that the mobile sensor data was obtained at step 311, can be collected and stored, or at least retained sufficiently long enough to fulfill the remaining steps of flow diagram 301. At step 331, the wireless signal observations that were collected at step 321 can be combined with the mobile sensor data that was received at step 311. Relevant processing can then end with the transmission of the combination generated at step 331, to one or more server computing devices, as illustrated by step 341.

Turning to flow diagram 302, the steps illustrated therein can be performed concurrently with those of the flow diagram 301, or they can be performed at a different time. Alternatively, certain wireless computing devices may comprise the capability to perform the steps of flow diagram 301 but not the steps of flow diagram 302, and vice versa. As illustrated, initially, at step 312, in the flow diagram 302, wireless signal observations can be received, such as when wireless communication components of the wireless computing device are polled for such observations. Subsequently, at step 322, the wireless signal observations obtained at step 312 can be transmitted to one or more server computing devices and the correlated context can be requested from those server computing devices. Optionally, at step 322, the request can further comprise a request for targeted information associated with the correlated context. At step 332, a correlated context can be received in response to the request at step 322. Again, optionally, at step 332, the received context can comprise targeted information. Based on the correlated context received at step 322, and optionally the targeted information, at step 342, targeted information can be selected for presentation to the user. The relevant processing can then end at step 352 when such selected targeted information is presented to the user.

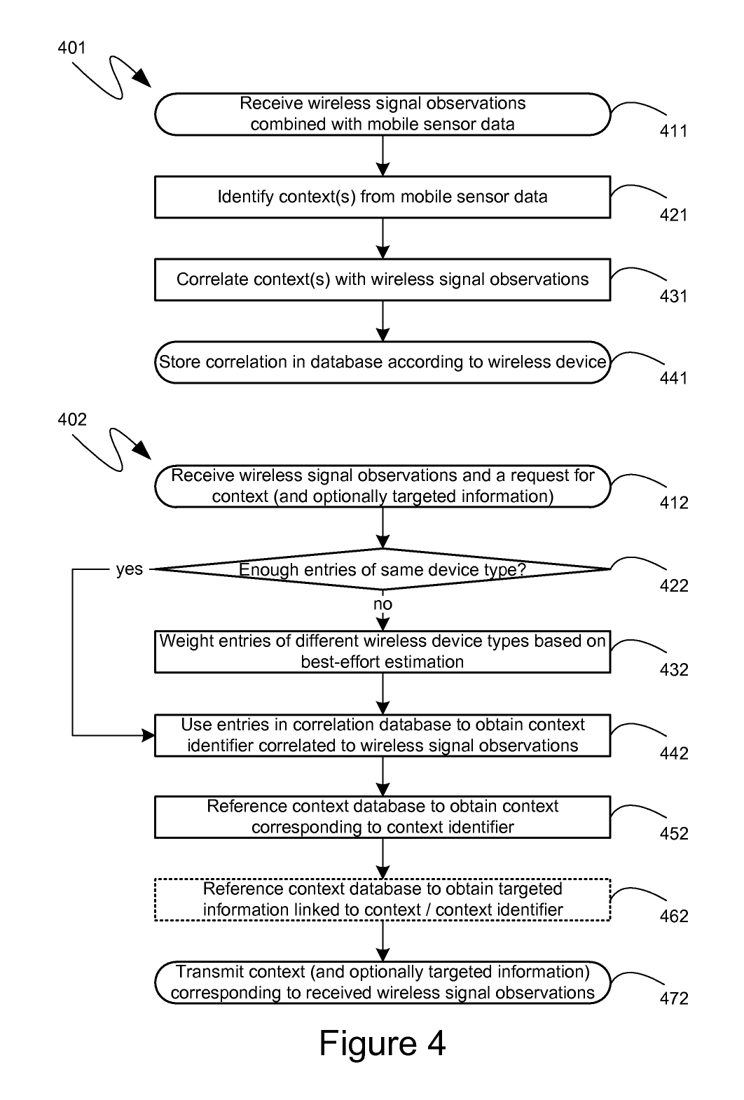

Turning to FIG. 4, the flow diagrams 401 and 402 illustrate an exemplary series of steps that can be performed by computer-executable instructions executing on one or more server computing devices. As such, the steps of the flow diagrams 401 and 402 can be performed concurrently on one or more server computing devices, or they can be performed by dedicated computing devices, such that one set of computing devices performs the steps of flow diagram 401, while another, different set of computing devices performs the steps of flow diagram 402. Turning to the flow diagram 401, initially, at step 411, wireless signal observations combined with mobile sensor data can be received. Subsequently, at step 421, the mobile sensor data that was received at step 411 can be utilized, such as with reference to a context information database, to identify one or more contexts from which such mobile sensor data could have been obtained. The wireless signal observations saved at step 411 can then be correlated, at step 431, with the one or more contexts identified at step 421. The relevant processing can end when the resulting correlation can be stored in a database at step 441. In one embodiment, at step 441, the storing of the correlation into the database can be done according to the wireless device from which the wireless signal observations and mobile sensor data were received at step 411.

Turning to the flow diagram 402, initially, at step 412, wireless signal observations can be received, together with a request for a context correlated with those wireless signal observations. Optionally, the received request, at step 412, can also comprise a request for targeted information based on the correlated context. At step 422, a context/wireless correlation database can be referenced and an initial determination can be made as to whether such a database comprises sufficient entries from a wireless computing device that is of the same type as that from which the request was received at step 412. If, at step 422, it is determined that there are insufficient entries within the context/wireless correlation database, then processing can proceed with step 432 at which entries from information collected from other types of wireless computing devices can be considered and re-weighted appropriately, such as on a best effort estimation. Processing can then proceed with step 442. Additionally, processing could proceed directly with step 442 if, at step 422, it was determined that the context/wireless correlation database comprised sufficient entries whose information was obtained by wireless computing devices of the same device, or similar device type, as the computing device from which the request was received at step 412. At step 442, entries in the context/wireless correlation database can be utilized to obtain a context identifier that is correlated to the wireless signal observations that were received at step 412. Subsequently, the context information database can be referenced at step 452 to obtain contextual information corresponding to the context identifier obtained at step 442. Optionally, at step 462, such a context information database can further be referenced to obtain targeted information that is linked to, or otherwise associated with the context obtained at step 452, or the context identifier obtained at step 442. Step 462 is illustrated via dashed lines to indicate that it is an optional step. Finally, at step 472, the relevant processing can end when the context obtained at step 452, and optionally the targeted information obtained at step 462, are transmitted to the wireless computing device from which the request was received at step 412, in response to the request received at step 412.

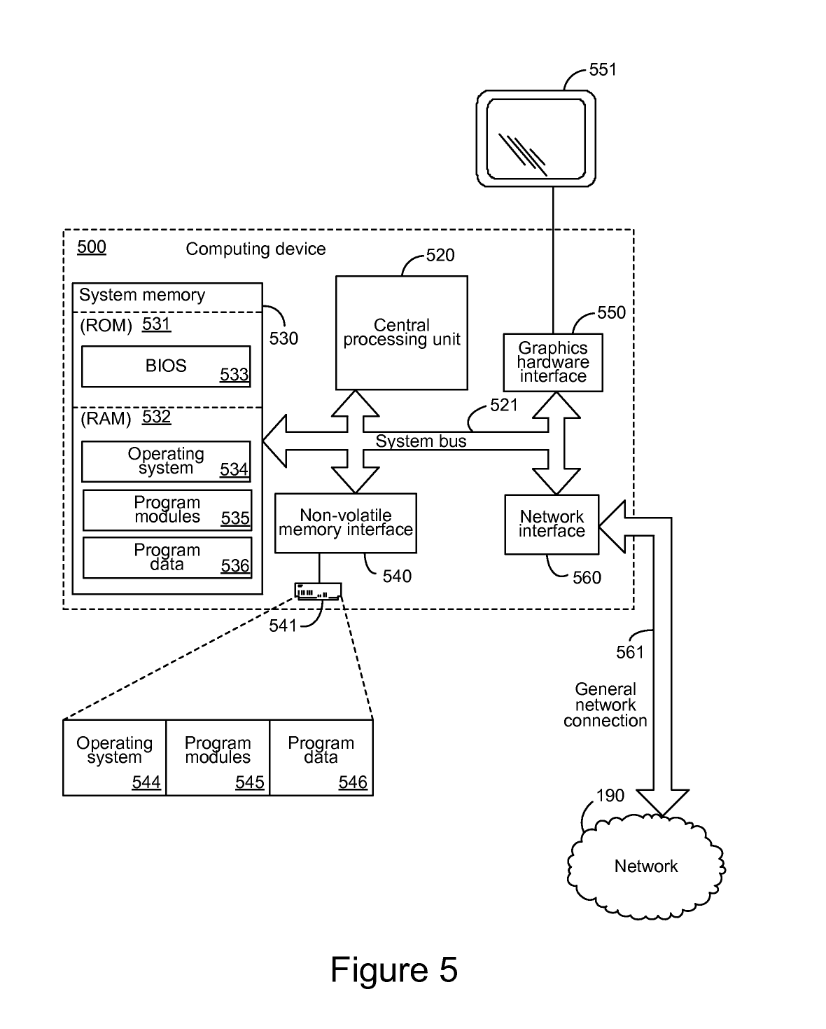

Turning to FIG. 5, an exemplary computing device 500 is illustrated. The exemplary computing device 500 can be any one or more of the computing devices illustrated in FIGS. 1 and 2, including general purpose computing devices, such as the wireless computing devices 140 and 170 and the server computing device 110, and also including dedicated computing devices, such as the access points 131 through 135, also shown in FIG. 1, and whose operations were described in detail above. The exemplary computing device 500 of FIG. 5 can include, but is not limited to, one or more central processing units (CPUs) 520, a system memory 530, that can include RAM 532, and a system bus 521 that couples various system components including the system memory to the processing unit 520. The system bus 521 may be any of several types of bus structures including a memory bus or memory controller, a peripheral bus, and a local bus using any of a variety of bus architectures. The computing device 500 can optionally include graphics hardware, such as for the display of a user interface, especially within the case of a general purpose computing device. Dedicated computing devices, such as an access point, may not comprise a display 551, per se, but they often comprise other visual user feedback hardware, such as Light Emitting Diodes (LEDs) and the like. The graphics hardware can include, but is not limited to, a graphics hardware interface 550 and a display device 551. Depending on the specific physical implementation, one or more of the CPUs 520, the system memory 530 and other components of the computing device 500 can be physically co-located, such as on a single chip. In such a case, some or all of the system bus 521 can be nothing more than silicon pathways within a single chip structure and its illustration in FIG. 5 can be nothing more than notational convenience for the purpose of illustration.

The computing device 500 also typically includes computer readable media, which can include any available media that can be accessed by computing device 500 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 500. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 530 includes computer storage media in the form of volatile and/or nonvolatile memory such as read only memory (ROM) 531 and the aforementioned RAM 532. A basic input/output system 533 (BIOS), containing the basic routines that help to transfer information between elements within computing device 500, such as during start-up, is typically stored in ROM 531. RAM 532 typically contains data and/or program modules that are immediately accessible to and/or presently being operated on by processing unit 520. By way of example, and not limitation, FIG. 5 illustrates the operating system 534 along with other program modules 535, and program data 536. As will be recognized by those skilled in the art, in dedicated computing devices, a single cohesive set of computer-executable instructions directed to the performance of the tasks to which the dedicated computing device is dedicated can comprise the operating system 534 and the program modules 535 and program data 536.

The computing device 500 may also include other removable/non-removable, volatile/nonvolatile computer storage media. By way of example only, FIG. 5 illustrates the hard disk drive 541 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540.

The drives and their associated computer storage media discussed above and illustrated in FIG. 5, provide storage of computer readable instructions, data structures, program modules and other data for the computing device 500. In FIG. 5, for example, hard disk drive 541 is illustrated as storing operating system 544, other program modules 545, and program data 546. Note that these components can either be the same as or different from operating system 534, other program modules 535 and program data 536. Operating system 544, other program modules 545 and program data 546 are given different numbers hereto illustrate that, at a minimum, they are different copies.

The computing device 500 can operate in a networked environment using logical connections to one or more remote computers. The computing device 500 is illustrated as being connected to a general network connection 561 through a network interface or adapter 560 that is, in turn, connected to the system bus 521. In a networked environment, program modules depicted relative to the computing device 500, or portions or peripherals thereof, may be stored in the memory of one or more other computing devices that are communicatively coupled to the computing device 500 through the general network connection 561. It will be appreciated that the network connections shown are exemplary and other means of establishing a communications link between computing devices may be used.

As can be seen from the above descriptions, mechanisms for generating context/wireless correlations without performing detailed calibration have been presented. In view of the many possible variations of the subject matter described herein, we claim as our invention all such embodiments as may come within the scope of the following claims and equivalents thereto.

We claim:

1. One or more computer-readable media comprising computer-executable instructions for correlating wireless signal observations to corresponding contexts, the computer-executable instructions performing steps comprising:
acquiring mobile sensor data comprising indicia of a context of a user, including the user's location;
acquiring, contemporaneously with the acquiring the mobile sensor data, wireless signal observations comprising a wireless signal strength from a wireless access point; and
transmitting the acquired mobile sensor data and the acquired wireless signal observations to a context/wireless correlation engine.

2. The computer-readable media of claim 1, wherein the computer-executable instructions for acquiring the mobile sensor data comprise computer-executable instructions for scanning a bar code of a product sold in a retail environment.

3. The computer-readable media of claim 1, wherein the computer-executable instructions for acquiring the mobile sensor data comprise computer-executable instructions for accepting manual user input.

4. The computer-readable media of claim 1, wherein the indicia of the context of the user further comprises policies of a retail environment within which is the user's location.

5. The computer-readable media of claim 1, wherein the wireless signal observations further comprise at least one of: a Basic Service Set Identifier (BSSID) of the wireless access point, a Service Set Identifier (SSID) of the wireless access point, a wireless network type provided by the wireless access point, a channel on which a wireless communicational connection is established with the wireless access point, and timing information about the wireless communication connection.

6. The computer-readable media of claim 1, comprising further computer-executable instructions for: acquiring other wireless signal observations independently of any acquiring of mobile sensor data; transmitting the other acquired wireless signal observations to a context/wireless resolution engine; and requesting, from the context/wireless resolution engine, a context correlated to the other wireless signal observations.

7. The computer-readable media of claim 6, comprising further computer-executable instructions for: receiving the context correlated to the other wireless signal observations from the context/wireless resolution engine in response to the requesting; and displaying, to the user, targeted information, selected based on the context correlated to the other wireless signal observations, the targeted information comprising at least one of: an advertisement and a coupon.

8. The computer-readable media of claim 7, comprising further computer-executable instructions for: additional requesting, from the context/wireless resolution engine, the targeted information.

9. The computer-readable media of claim 7, comprising further computer-executable instructions for: selecting the targeted information based on the context correlated to the other wireless signal observations received from the context/wireless resolution engine.

10. One or more computer-readable media comprising computer-executable instructions for correlating wireless signal observations to corresponding contexts, the computer-executable instructions performing steps comprising:
receiving, from a first wireless computing device, mobile sensor data acquired by the first wireless computing device and wireless signal observations acquired by the first wireless computing device contemporaneously with the acquiring of the mobile sensor data;
obtaining a context that the mobile sensor data is indicative of;
generating a correlation between the context and the wireless signal observations; and
storing the generated correlation in a context/wireless correlation database.

11. The computer-readable media of claim 10, wherein the computer-executable instructions for storing the generated correlation comprise computer-executable instructions for storing the generated correlation in the context/wireless correlation database according to a model of the first wireless computing device.

12. The computer-readable media of claim 11, comprising further computer-executable instructions implementing a correlation maintenance engine that can edit stored correlations in the context/wireless correlation database.

13. The computer-readable media of claim 10, wherein the computer-executable instructions for obtaining the context comprise computer-executable instructions for referencing a context information database to: identify a product associated with the mobile sensor data, identify a retail environment associated with the wireless signal observations, and identify a location of the identified product in the identified retail environment.

14. The computer-readable media of claim 13, comprising further computer-executable instructions implementing a context maintenance engine, accessible by multiple independent parties through a web page interface, that can edit contextual information in the context information database.

15. The computer-readable media of claim 9, comprising further computer-executable instructions for: receiving, from a second wireless computing device, a request for a second context correlated to second wireless signal observations acquired by the second wireless computing device; receiving, from the second wireless computing device, the second wireless signal observations; referencing correlations stored in the context/wireless correlation database to identify the second context correlated to the second wireless signal observations; and providing the identified second context to the second wireless computing device in response to the request.

16. The computer-readable media of claim 15, wherein the computer-executable instructions for referencing the correlations comprise computer-executable instructions for: first referencing correlations stored in the context/wireless correlation database that are based on a same device model as the second wireless computing device; and weighting other correlations stored in the context/wireless correlation database that are based on a different device model from the second wireless computing device if there are an insufficient number of the correlations stored in the context/wireless correlation database that are based on the same device model as the second wireless computing device.

17. The computer-readable media of claim 15, wherein the computer-executable instructions for referencing the correlations comprise computer-executable instructions for weighting correlations stored in the context/wireless correlation database based on an age of those correlations.

18. The computer-readable media of claim 15, comprising further computer-executable instructions for: receiving, from the second wireless computing device, a request for targeted information associated with the second context; referencing a context information database to identify the targeted information associated with the second context; and providing the identified targeted information to the second wireless computing device in response to the request for the targeted information.

19. An advertising system providing targeted information to users based on their current context, the system comprising:
an application program for execution on a wireless computing device, the application program comprising computer-executable instructions performing steps comprising: acquiring mobile sensor data comprising indicia of a context of a user of the wireless computing device, including the user's location; acquiring, contemporaneously with the acquiring the mobile sensor data, wireless signal observations comprising a wireless signal strength, from a wireless access point, as received by the wireless computing device; and transmitting the acquired mobile sensor data and the acquired wireless signal observations; and
one or more server computing devices comprising one or more computer-readable media, the one or more computer-readable media comprising computer-executable instructions performing steps comprising: receiving, from the application program executing on the wireless computing device, the acquired mobile sensor data and the acquired wireless signal observations; obtaining a context that the received mobile sensor data is indicative of; generating a correlation between the context and the received wireless signal observations; and storing the generated correlation in a context/wireless correlation database.

20. The advertising system of claim 19, wherein the application program further comprises computer-executable instructions for: acquiring other wireless signal observations independently of any acquiring of mobile sensor data; transmitting the other acquired wireless signal observations; and requesting a context correlated to the other wireless signal observations; and wherein further the one or more server computing devices comprise further computer-readable media comprising computer-executable instructions for: receiving, from the application program, the request for the context correlated to the other wireless signal observations; receiving, from the application program, the other wireless signal observations; referencing correlations stored in the context/wireless correlation database to identify the context correlated to the other wireless signal observations; and providing the identified context correlated to the other wireless signal observations to the application program in response to the request.
